(19) United States
(12) Patent Application Publication
(10) Pub. No.: US 2007/0138979 A1
(43) Pub. Date: Jun. 21, 2007

(54) LED illumination unit, projection display device using the same, and method of operating LED illumination unit

(75) Inventors: Sachiyo Yamada, Yokohama (JP); Tsutomu Nishida, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/641,052

(22) Filed: Dec. 19, 2006

(30) Foreign Application Priority Data
Dec. 20, 2005 (JP) 2005-366324
Sep. 14, 2006 (KR) 10-2006-0089156

(51) Int. Cl. H05B 41/36

(52) U.S. Cl. 315/291

(57) ABSTRACT

An LED illumination unit, a projection display device using the LED illumination unit, and a method of operating the LED illumination unit are provided. The LED illumination unit includes a light source with a plurality of LEDs, and a lighting control unit which sequentially turns on the LEDs for lighting time sections which are assigned for each LED in a cyclic time period. The lighting control unit includes a driving signal modulator which generates a modulation signal for turning on at least one of the LEDs with a lighting duty that is shorter than the lighting time section for the at least one of the LEDs. The method includes sequentially turning on a plurality of LEDs of the LED illumination unit for lighting time sections which are assigned for each LED in a cyclic time period. At least one of the LEDs is turned on with a lighting duty that is shorter than its lighting time section.

### CROSS-REFERENCE TO RELATED PATENT APPLICATION

This application claims priority from Japanese Patent Application No. 2005-366324, filed on Dec. 20, 2005 in the Japanese Intellectual Property Office, and Korean Patent Application No. 10-2006-0089156, filed on Sep. 14, 2006 in the Korean Intellectual Property Office, the disclosures of which are incorporated herein in their entirety by reference.

### BACKGROUND OF THE INVENTION

1. Field of the Invention

Apparatuses and methods consistent with the present invention relate to a light emitting diode (LED) illumination unit, a projection display device which uses the LED illumination unit, and a method of operating the LED illumination unit, and more particularly, to displaying an image by irradiating light onto a display medium, such as a reflective screen or a transmissive screen.

2. Description of the Related Art

In related art projection display devices, such as projectors and rear projection televisions, LEDs are used as light sources and operated by a pulse lighting method.

For example, when a full-color image is projected using LEDs emitting light of three primary colors, such as red, green, and blue, red, green, and blue light is sequentially emitted by a time division method, and is spatially modulated using image signals corresponding to each color of light.

In Japanese Patent Application Publication Number 2005-149132 (FIGS. 2 and 4), an image processing device for picking up and processing an image and an electronic component mounting apparatus with the image processing device are disclosed. The image processing device includes a light source having a plurality of LEDs, and an LED driving circuit which adjusts the brightness of light emitted from the LEDs using a pulse-width modulation method.

Further, an LED driving circuit is disclosed in Japanese Patent Publication Number 2005-5112 (FIGS. 1, 2, and 3). The disclosed LED driving circuit generates a current signal having a triangular waveform with an offset, and switches the current signal at a frequency higher than an optical response frequency of a human eye by using a current detector and a switch controller, in order to operate LEDs approximately in a constant current mode.

However, the related art visible-light LED light source, the projection display device using the LED light source, and the method of operating the LED light source have the following disadvantages.

While an LED emits light, the LED produces heat, and this heat decreases the optical output of the LED. Therefore, when the LED is turned on for a long time to provide a high-brightness illumination, the light emitting efficiency of the LED decreases with time, and the life span of the LED also decreases.

For example, in an LED light source in which red, green, and blue LEDs are assembled to generate white light, a decrease in brightness can occur more easily, since the LEDs thermally affect each other. Furthermore, the red, green, and blue LEDs have different thermal characteristics, depending on their colors. Therefore, the red, green, and blue LEDs have different brightnesses and life spans. Therefore, it is difficult to adjust the brightness and driving time of the LEDs for reliable operation.

To address these problems, the brightness of LEDs can be adjusted according to the Japanese Patent Application Publication Number 2005-149132. However, the pulse-width modulation method disclosed in this publication is designed for picking up an image using a light source. In the disclosed pulse-width modulation method, the brightness of an object is measured, and a pulse-width modulation signal is generated using the measured results in order to obtain a desired exposing energy.

For an LED illumination unit that forms an image by sequentially irradiating red, green, and blue light onto a display medium, such as a reflective screen or a transmissive screen, the necessary exposing energy is transferred by a pulse-width modulation, and a time period in which the red, green, and blue light is sequentially irradiated includes an off-duty interval. Due to the off-duty interval, the frequency of the light color changing decreases, causing problems related to image quality, such as a blinking increase.

Furthermore, the Japanese Patent Application Publication Number 2005-5112, which is related to an LED driving circuit used for lighting devices of a car or traffic lights, suggests that even when a square driving current signal is rippled, the LEDs can be driven approximately in a constant current mode by modulating the driving current signal using a frequency higher than the optical response frequency of a human eye. However, this publication does not disclose or suggest an LED driving circuit and a method for reducing a brightness decrease of an LED.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an LED illumination unit which can be reliably operated by reducing brightness decreases of visible-light LEDs caused by heat generated by the LEDs when the LEDs are sequentially turned on to irradiate light onto a display medium for displaying an image on the display medium. The present invention also provides a projection display device which uses the LED illumination unit, and a method of operating the LED illumination unit.

According to an aspect of the present invention, there is provided an LED illumination unit including a light source including a plurality of LEDs; and a lighting control unit which sequentially turns on the LEDs for lighting time sections which are assigned for each LED in a cyclic time period, wherein the lighting control unit includes a driving signal modulator which generates a modulation signal for turning on at least one of the LEDs with a lighting duty that is shorter than the lighting time section.

According to another aspect of the present invention, there is provided a projection display device which uses the LED illumination unit.

According to another aspect of the present invention, there is provided a method of operating an LED illumination unit, the method including sequentially turning on a plurality of LEDs of the LED illumination unit for lighting time sections which are assigned for each LED in a cyclic time period, wherein at least one of the LEDs is turned on with a lighting duty which is shorter than the lighting time section.

According to the present invention, at least one of the visible-light LEDs is turned on with a lighting duty that has a smaller width than the lighting time section. Therefore, this LED generates less heat compared with other LEDs which are turned on at 100% duty ratio in a lighting time section, since the LED is turned on at a duty ratio less than 100%. Further, heat can be easily released from the LED during an off-duty interval in the lighting section when the LED is turned off. Accordingly, the temperature of the light source can be reduced.

The term duty ratio denotes a ratio of a lighting time in a given lighting time section to the entire lighting time section. The waveform of the modulation signal is not limited to a square waveform.

In this case, although the LED is turned off for an off-duty interval in the lighting time section, it can be adjusted so that a human eye does not perceive the turning off of the LED, by varying the brightness of the LED and the off-duty width in the given lighting time section. In the afterimage phenomenon, an optical stimulus remains after the stimulus ends. Therefore, a person perceives that the LED is continuously turned on to display an image.

For example, in an LED illumination unit of a projection display device that sequentially turns on LEDs to display a full-color image, red, green, and blue light is sequentially emitted in lighting time sections of a given time period. The time period is set such that a human eye perceives a mixed color of the red, green, and blue colors in the time period. Therefore, an off-duty period which is smaller than the lighting time section is not perceived by a human eye when the brightness level of the LED is properly set.

Furthermore, a sufficiently small gap between off-duties increases a difference between a physical integral value of the brightness of an LED and a brightness level of the LED perceived by an eye of a person. The LED appears to be brighter compared with the physical integral value of the brightness of the LED.

The lighting time section can be set such that an integral value of a modulation signal having a duty ratio less than 100% is smaller than an integral value of a modulation signal having a duty ratio of 100%. In this case, a brightness decrease of the LED can be more effectively prevented, since the heat generated by the LED is reduced in comparison with the case of a 100% duty ratio.

### BRIEF DESCRIPTION OF THE DRAWINGS

The above and other aspects of the present invention will become more apparent by describing in detail exemplary embodiments thereof with reference to the attached drawings in which:

FIG. 1 is a schematic view illustrating a projection display device using an LED illumination unit according to an exemplary embodiment of the present invention;

FIG. 2 is a function block diagram illustrating a structure of the LED illumination unit depicted in FIG. 1, according to an exemplary embodiment of the present invention;

FIG. 3 is a graph illustrating modulation signals for a plurality of LEDs of the LED illumination unit depicted in FIG. 1, according to an exemplary embodiment of the present invention;

FIG. 4 is a graph illustrating a detail waveform pattern of the modulation signal depicted in FIG. 3, the modulation signal being generated by a driving signal modulator of the LED illumination unit according to an exemplary embodiment of the present invention;

FIG. 5 is a graph illustrating response of an eye to an optical stimulus as a function of time;

FIG. 6 is a graph illustrating a decrease in brightness of an LED;

FIG. 7 is a graph illustrating a waveform pattern of a modulation signal generated by a driving signal modulator of an LED illumination unit according to an exemplary embodiment of the present invention; and

FIG. 8 is a graph illustrating a waveform pattern of a modulation signal generated by a driving signal modulator of an LED illumination unit according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. Like reference numerals in the drawings denote like elements, and thus their description will be omitted.

An LED and a projection display device using the LED will now be described according to an exemplary embodiment of the present invention.

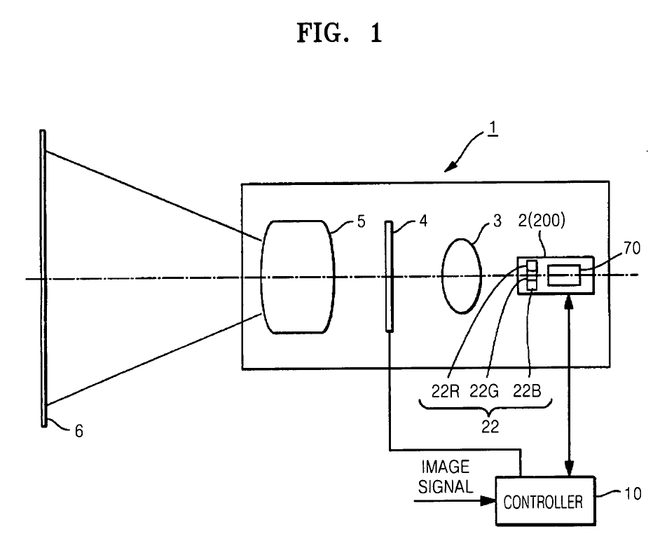

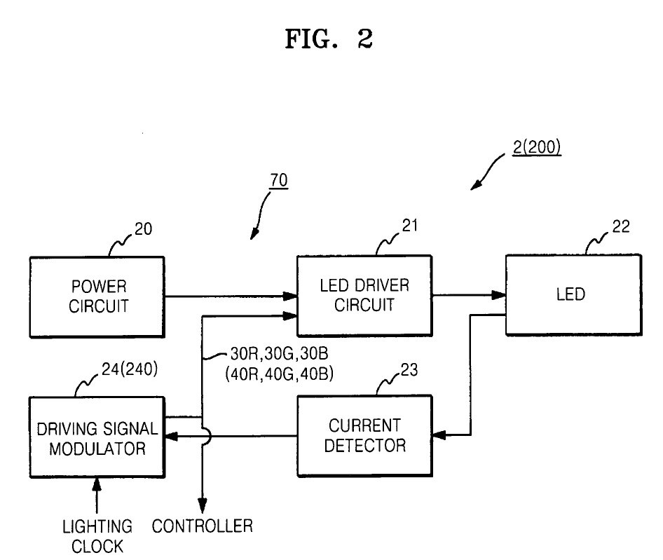

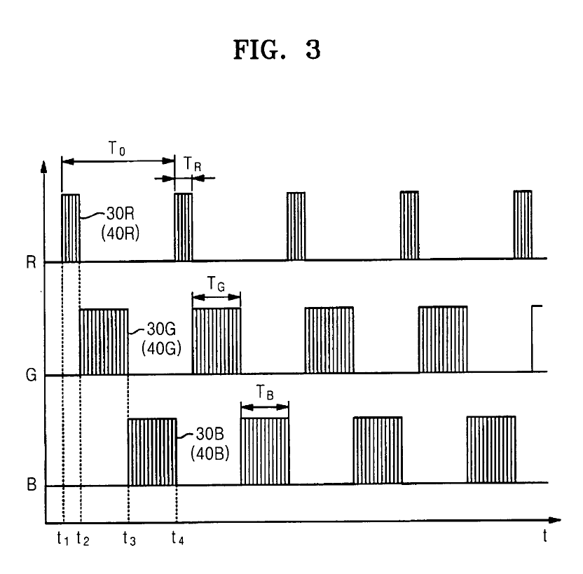

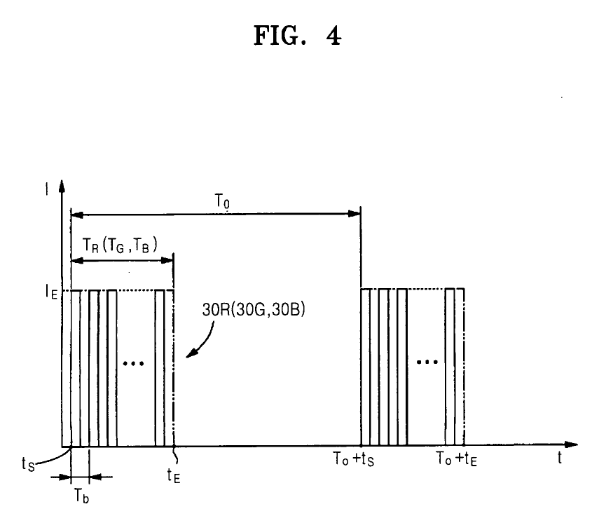

FIG. 1 is a schematic view illustrating a projection display device 1 using an LED illumination unit 2 according to an exemplary embodiment of the present invention. FIG. 2 is a function block diagram illustrating the LED illumination unit 2 according to an exemplary embodiment of the present invention. FIG. 3 is a graph illustrating modulation signals for a plurality of LEDs of the LED illumination unit 2 according to an exemplary embodiment of the present invention. FIG. 4 is a graph illustrating a detail waveform pattern of the modulation signal depicted in FIG. 3, the modulation signal being generated by a driving signal modulator of the LED illumination unit 2 according to an exemplary embodiment of the present invention.

The projection display device 1 projects a full-color image onto a reflective screen 6 using the LED illumination unit 2 based on an image signal input.

The projection display device 1 includes the LED illumination unit 2, a condensing lens 3, a spatial modulator 4, a projection lens 5, and a controller 10 which controls the overall operation of the projection display device 1.

The LED illumination unit 2 sequentially generates light of different wavelengths corresponding to at least three primary colors, such as red, green, and blue, by a time division method, in order to display a full-color image.

The condensing lens 3 receives light emitted from the LED illumination unit 2, and focuses the light onto a modulation region of the spatial modulator 4.

The spatial modulator 4 displays a color-separated image for projection by spatially modulating the light from the condensing lens 3 based on an image signal of corresponding wavelength light. The spatial modulator 4 is driven by the controller 10. A transmissive device, such as a liquid crystal display (LCD), or a reflective device, such as a digital micromirror device (DMD) having a micro mirror array structure and a liquid crystal on silicon (LCOS), can be used as the spatial modulator 4.

The projection lens 5 projects the image displayed on the spatial modulator 4 onto the reflective screen 6 at an enlarged size.

The structure of the LED illumination unit 2 will now be described in detail.

Referring to FIGS. 1 and 2, the LED illumination unit 2 includes a light source 22, an LED driver circuit 21, a current detector 23, a driving signal modulator 24, and a power circuit 20 which supplies power to the light source 22.

The light source 22 includes LEDs 22R, 22G, and 22B which emit three primary light colors, such as red, green, and blue wavelength light, respectively. The LEDs 22R, 22G, and 22B are grouped within an area in which they affect each other thermally.

The LED driver circuit 21, the current detector 23, and the driving signal modulator 24 are used to sequentially turn on the LEDs 22R, 22G, and 22B for their respective lighting times in every cyclic time period, based on a lighting clock signal of the controller 10. The LED driver circuit 21, the current detector 23, and the driving signal modulator 24 make up a lighting control unit 70.

The lighting clock signal is a signal which obtains lighting timing for sequentially turning on the LEDs in every cyclic time period. The lighting signal can have the same frequency range as in the related art, such as 180 Hz to 360 Hz. In the current exemplary embodiment, a lighting fundamental frequency f₀ is 240 Hz.

The LED driver circuit 21 switches a current from the power circuit 20 based on a modulation signal from the driving signal modulator 24 in order to individually drive the LEDs 22R, 22G, and 22B.

The current detector 23 measures current flowing through the LEDs 22R, 22G, and 22B of the light source 22 according to a predetermined schedule in order to generate a control signal for maintaining the maximal luminous outputs of the LEDs 22R, 22G, and 22B at a predetermined level, and to send the control signal to the driving signal modulator 24.

The driving signal modulator 24 generates a modulation signal for dividing the cyclic time period set by the lighting clock signal into lighting time sections for the LEDs 22R, 22G, and 22B of the light source 22. In a given lighting time section of the cyclic time period, a corresponding one of the LEDs 22R, 22G, and 22B is turned on for a lighting duty fraction which is shorter than the given lighting time section. The term lighting duty denotes a fraction of the lighting time section during which one of the LEDs is on.

In an exemplary embodiment shown in FIG. 3, in a period T₀ determined by a lighting fundamental frequency f₀, such that T₀=1/f₀=t₄-t₁, modulation signals 30R, 30G, and 30B are generated to drive the LEDs 22R, 22G, and 22B by a sequential time division method. For example, red, green, and blue wavelength light is emitted in lighting time sections T_{R} (t₁ to t₂), T_{G} (t₂ to t₃), and T_{B} (t₃ to t₄), respectively, where t₁<t₂<t₃<t₄.

The widths of the lighting time sections T_{R}, T_{G}, and T_{B} are individually determined based on the thermal characteristics of the LEDs 22R, 22G, and 22B. In the current exemplary embodiment, since the LEDs 22G and 22B have substantially the same thermal characteristic, and the LED 22R has a relatively bad thermal characteristic, the lighting time sections T_{R}, T_{G}, and T_{B} are set as follows: T_{R}/T₀=0.2 (20%), T_{G}/T₀=0.4 (40%), and T_{B}/T₀=0.4 (40%).

In a related art lighting method, the LEDs 22R, 22G, and 22B may be on at a duty ratio of 100% in the lighting time sections T_{R}, T_{G}, and T_{B}. In a related art pulse-width modulation method for lighting, the lighting time sections T_{R}, T_{G}, and T_{B} are determined with respect to the fundamental frequency f₀ in such a manner that duty ratios for the LEDs 22R, 22G, and 22B are T_{R}/T₀, T_{G}/T₀, and T_{B}/T₀, respectively, since lighting is performed at a duty ratio of 100% within a given lighting time section. Further, driving currents supplied to the LEDs 22R, 22G, and 22B for the modulation signals 30R, 30G, and 30B are determined based on the duty ratios, in order to obtain a desired optical energy density at the reflective screen 6.

However, in the exemplary embodiments shown in FIGS. 3 and 4, a modulation signal 30R, 30G, or 30B is a pulse-width modulation signal which has a burst frequency f_{b} higher than a lighting fundamental frequency f₀ within a given lighting time section T_{R}, T_{G}, or T_{B}, respectively, of a time period T₀. In FIG. 4, tₛ and t_{E} denote the start and end points of a given lighting time section T_{R}, T_{G}, or T_{B}.

The burst frequency f_{b} and the duty ratio may be properly selected based on experiments conducted to obtain a relationship between LED brightness decrease due to heat generation, and actual brightness perceived by the eye. Particularly, the burst frequency f_{b} may be selected from high frequencies, such that at least two pulses can be generated in a given lighting time section T_{R}, T_{G}, or T_{B}.

For example, the pulse-width modulation may be set as follows: f_{b}=20·f₀, T_{b} (pulse period)=1/f_{b}, and duty ratio=50%.

In this case, the power required for driving the LEDs 22R, 22G, and 22B is reduced by half, compared with using a duty ratio of 100%.

Further, the modulation signal 30R, 30G, or 30B can have the same peak value as a related art pulse-width modulation signal. For example, a peak driving current may be 1.5A for the modulation signal 30R (30G, 30B).

The modulation signal 30R, 30G, or 30B is sent to the controller 10 to generate a timing signal for driving the spatial modulator 4.

Functions of the LED illumination unit 2 will now be described with regard to operation of the projection display device 1.

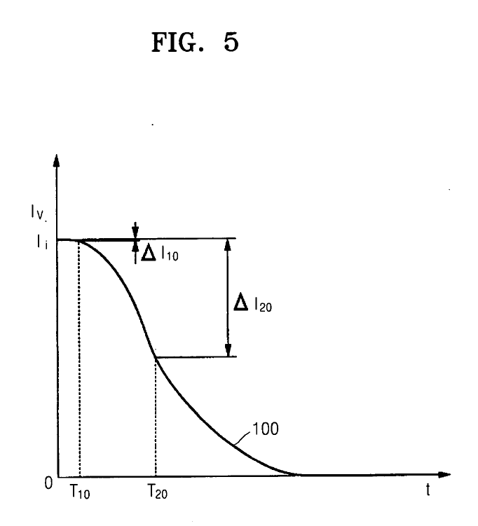

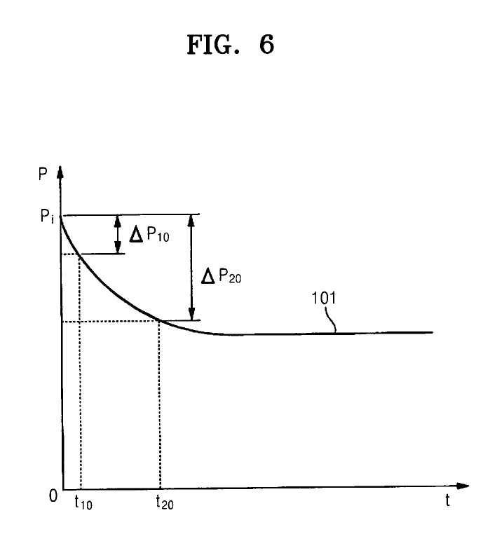

FIG. 5 is a graph illustrating the response of an eye to an optical stimulus as a function of time. FIG. 6 is a graph illustrating a decrease in brightness of an LED.

When the controller 10 of the projection display device 1 receives color-separated red, green, and blue image signals, the controller 10 sends a clock signal to the LED illumination unit 2.

Then the driving signal modulator 24 of the LED illumination unit 2 generates modulation signals 30R, 30G, and 30B, and sends them to the LED driver circuit 21. Driving currents corresponding to the modulation signals 30R, 30G, and 30B can then be supplied to the LEDs 22R, 22G, and 22B of the light source 22. Therefore, the LEDs 22R, 22G, and 22B can be individually operated, based on the waveform patterns of the modulation signals 30R, 30G, and 30B.

The modulation signals 30R, 30G, and 30B are also sent to the controller 10 to generate a timing signal for the spatial modulator 4. Therefore, the driving timing of the spatial modulator 4 can be synchronized with red, green, and blue wavelength light emitted from the light source 22 in the lighting time sections T_{R}, T_{G}, and T_{B}. In this way, the spatial modulator 4 can be operated based on red, green, and blue image signals in a time division manner.

Red, green, and blue light emitted from the LED illumination unit 2 is condensed and focused by the condensing lens 3 onto the spatial modulator 4. The spatial modulator 4 spatially modulates the red, green, and blue light in order to display color-separated images of red, green, and blue. The color-separated images displayed on the spatial modulator 4 are enlarged by the projection lens 5 and projected onto the reflective screen 6. Since the color-separated images are combined at a person's eyes, the person can see a full-color image from color-sequential light reflected by the reflective screen 6.

In the pulse-width modulation of the present invention, a pulse width is modulated at a duty ratio less than 100% in the same lighting time section as the lighting time section in the related art pulse-width modulation. However, the LED illumination unit 2 can be used without the problems related to a brightness decrease, although the duty ratio in the lighting time section is less than 100%. The reason for this will now be explained.

In the current exemplary embodiment, since the duty ratio is 50%, the amount of light emitted from the light source 22 is less than the amount of light emitted when the duty ratio is 100%. Therefore, when the light source 22 is used as a light source of a printer in which the light source is used to scan a photoconductor having a certain photosensitivity, the scanning energy decreases with a decreasing duty ratio.

However, for an LED illumination unit that displays images by irradiating visible light onto a display medium, such as a reflective screen or a transmissive screen, a person's eyes cannot perceive a brightness decrease of the images caused by a decrease in the optical output power of the LED illumination unit, when the LED illumination unit is operated in a predetermined manner.

When a person's eyes receive an optical stimulus, the person perceives that the optical stimulus continues for a time after the optical stimulus ends. This is called the afterimage phenomenon. Referring to FIG. 5, when an eye sees a light pulse having an intensity Iᵢ, a perceptual intensity Iᵥ of the light pulse attenuates with time. A perceptual intensity curve 100 decreases gradually and then more steeply.

Due to this afterimage phenomenon, sequentially irradiated red, green, and blue light can be perceived as white light. Light of different colors can be mixed in this way at a frequency used by a projector. However, the perceptual intensity of the light is not very different from the actual light intensity. This can be understood from the case where the white balance is disrupted when lighting time sections for red, green, and blue colors are changed, or the case where red, green, and blue light are simultaneously irradiated for white lighting after sequentially irradiating red, green, and blue light in order to increase the perceptual brightness of an image.

Referring to FIG. 4, as the burst frequency f_{b} (1/T_{b}) increases above the fundamental frequency f₀ (1/T₀), it becomes more difficult for a person's eyes to perceive the discrete light pulses in the lighting time section T_{R}, T_{G}, or T_{B}, due to the afterimage phenomenon. As a result, an image can be displayed more brightly, compared with the amount of light emitted from the light source 22. The modulation signals 30R, 30G, and 30B are generated based on this fact.

Further, according to an exemplary embodiment of the present invention, since the amount of light emitted from the light source 22 can be reduced, heat generated by the light source 22 can be reduced, and thus problems related to a brightness decrease of the light source 22 due to heat generation can be reduced. This will now be described in more detail.

FIG. 6 is a graph which illustrates a decrease in the brightness of an LED due to heat generation. In FIG. 6, the horizontal axis denotes lighting time (t), and the vertical axis denotes brightness (P).

When an LED emits light continuously while receiving a constant driving current, the temperature of the LED increases, due to the generation of heat. Therefore, the brightness P of the LED decreases from an initial brightness Pᵢ based on the temperature characteristic of the LED, as shown by a brightness curve 101 in FIG. 6. Then, as the temperature of the LED reaches an equilibrium state, the brightness P of the LED approaches a constant value.

For example, when the LED is turned on for an interval from zero to t₁₀, the brightness P of the LED decreases by ΔP₁₀. When the LED is turned on for an interval from zero to t₂₀, where t₁₀<t₂₀, the brightness P of the LED decreases by ΔP₂₀. Further, since the amount of heat generation increases with lighting time, the LED generates less heat when turned on for a short interval from zero t₁₀, than when turned on for a long interval from zero to t₂₀. Therefore, when the total lighting time is equal, the brightness of the LED decreases much less in the case of a high-frequency pulse-width modulation. Thus, lighting can be performed efficiently by using the high-frequency pulse-width modulation.

This advantage is particularly significant for projection display devices which require very bright illumination light, such as projectors and projection televisions.

As explained above, according to exemplary embodiments of the present invention, modulation signals are pulse-width modulated so they have a duty ratio less than 100% in a given lighting time section, and a burst frequency f_{b} sufficiently higher than a fundamental lighting frequency f₀. Therefore, although the amount of light emitted from the light source 22 is reduced when compared with the related art pulse-width modulation method, the perceptual amount of light can be maintained at substantially the same level as in the related art pulse-width modulation, due to the afterimage effect. Furthermore, heat generated by the light source 22 and the resulting decrease in brightness of the light source 22 can be largely reduced. Accordingly, the LEDs 22R, 22G, and 22B of the light source 22 can be used reliably.

According to exemplary embodiments of the present invention, in the LED illumination unit 2, the driving signal modulator 24 generates a modulation signal for at least one of the LEDs 22R, 22G, and 22B by the above-described pulse-width modulation method, such that the LED can be operated in a given lighting time section based on the pulse-width modulation signal.

Furthermore, the brightness decrease of the LED can be prevented or reduced simply by adjusting the width of light pulses of the modulation signal, which changes the duty ratio.

An LED illumination unit will now be described according to an exemplary embodiment of the present invention.

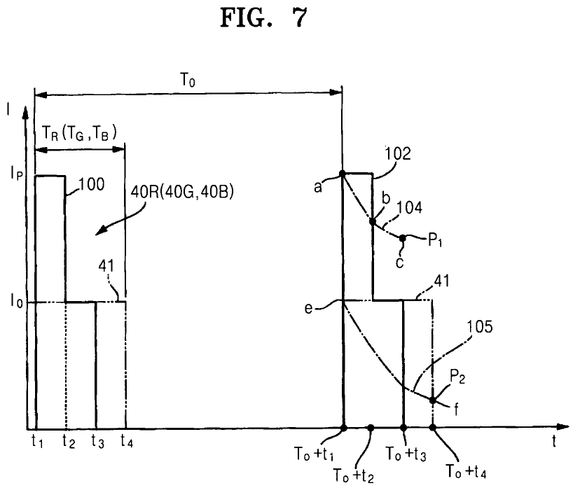

FIG. 7 is a graph illustrating a waveform pattern of a modulation signal generated by a driving signal modulator 240 of an LED illumination unit 200 according to an exemplary embodiment of the present invention.

The LED illumination unit 200 of the current embodiment has the same configuration as the LED illumination unit 2 shown in FIG. 2 except that the LED illumination unit 200 includes the driving signal modulator 240.

The driving signal modulator 240 of the LED illumination unit 200 generates a modulation signal 40R, 40G, or 40B that is different from the above-described modulation signals 30R, 30G, or 30B.

The modulation signal 40R, 40G, or 40B is generated in a lighting time section T_{R}, T_{G}, or T_{B} of a time period in the same manner as in the embodiment of FIG. 3.

Referring to FIG. 7, the waveform pattern is a power modulation waveform pattern having a stepped shape in which a signal level varies from Iₚ (from t₁ to t₂) to Iₒ (from t₂ to t₃). The lighting time section T_{R}, T_{G}, or T_{B}=t₄-t₁, where t₁<t₂<t₃<t₄, and I_{P}>I₀.

The peak value I_{P} and lighting duties t₂-t₁ and t₃-t₂ can be set based on experiment results showing a relationship between a brightness decrease and a perceptual brightness change of a human eye. The peak value I_{P} is restricted by a limit on the amplitude and duration of the driving current of the LEDs 22R, 22G, and 22B, in order to prevent reducing the life spans of the LEDs 22R, 22G, and 22B.

The function of the modulation signal 40R, 40G, or 40B will now be described provided that Iₚ=2·I₀, (t₂-t₁)=(⅓)·(t₄-t₁), and (t₃-t₁)=(⅔)·(t₄-t₁).

Referring to FIG. 7, a stepped pulse 100 given by the above-described settings may result in the same amount of heat generated by the LEDs 22R, 22G, and 22B as a modulation square pulse 41 having a signal level I₀ and 100% duty ratio in a given lighting time section.

A curve 104 indicates a brightness decrease when the LEDs 22R, 22G, and 22B are driven by the stepped pulse 100 of the current exemplary embodiment, and a curve 105 indicates a brightness decrease when the LEDs 22R, 22G, and 22B are driven by the modulation square pulse 41. In FIG. 7, although the brightness curves 104 and 105 are plotted only in a second period after a first period T₀, the brightness curves 104 and 105 are the same in all periods. Thus, the following descriptions of the brightness curves 104 and 105 will be given with respect to only the first period T₀ for clarity.

Since the modulation signal 40R, 40G, or 40B of the current embodiment starts with the peak value Iₚ, the brightness curve 104 runs from a maximum point (a) down to a point (b), in the form of the curve 101 shown in FIG. 6, during a time interval from t₁ to t₂. Then, in the next time interval from t₂ to t₃, the level of the modulation signal 40R, 40G, or 40B steps down to a value I₀ which is about half of the peak value I_{P}. Therefore, the heat generated by the LED reduces by half, and the brightness curve 104 runs from the point (b) to a point (c) in the time interval from t₂ to t₃ less steeply than in the time interval from t₁ to t₂. At the point (c), the brightness is P₁. In a time interval from t₃ to t₄, the LED is off. However, a person's eyes cannot perceive that the LED is off. Therefore, the brightness P₁ remains for a while.

For the modulation square pulse 41, since the level of the pulse 41 is maintained at a constant value I₀, which is half the value of I_{P}, the brightness curve 105 starts at a point (e) with a height half the height of the point (a), and proceeds down to a point (f) where the brightness is P₂ (P₂<P₁) in the form of the curve 101 shown in FIG. 6 during a time interval t₁ to t₄.

Although the total heat generated by the LED is the same for the stepped pulse 100 of the current exemplary embodiment and the square pulse 41, the brightness of the LED decreases much less for the stepped pulse 100 than the square pulse 41. Furthermore, due to the afterimage phenomenon, a person's eyes perceive the light emitted from the LED as much brighter when the LED is driven by the stepped pulse 100 instead of the square pulse 41.

Although the amount of heat generated by the LED is the same for the stepped pulse 100 and the square pulse 41, the amount of the heat generated by the LED can be reduced for the stepped pulse 100, such as by adjusting the peak value Iₚ of the pulse 100 and the time points t₂ and t₃.

As explained above, in the current exemplary embodiment, the driving signal modulator 240 of the LED illumination unit 200 generates a power modulation signal 40R, 40G, or 40B having a peak value I_{P} in an initial fraction of the lighting time section T_{R}, T_{G}, or T_{B}, for at least one of the LEDs 22R, 22G, and 22B.

The LED emits light with a maximum brightness in the initial fraction of the time section T_{R}, T_{G}, or T_{B} when the accumulated heat is low, so that the light emitting efficiency of the LED is improved. Thus, high-brightness operation of the LED is possible.

Furthermore, in the current exemplary embodiment, the level of the power modulation signal 40R, 40G, or 40B starts with a peak value, and decreases with time in monotone.

In this case, the heat generated by the LED decreases in monotone, so the brightness decrease of the LED can be efficiently reduced.

Here, the term monotone is used to denote a monotone decreasing in a broad sense, including a stepped decreasing.

Another exemplary embodiment of the present will now be described.

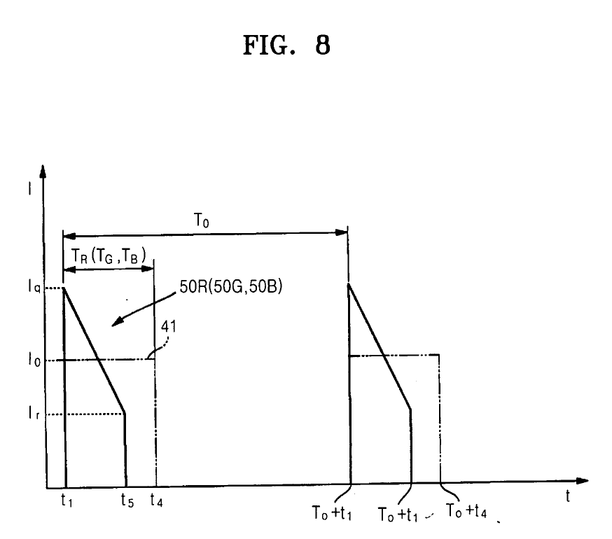

FIG. 8 is a graph illustrating a waveform pattern of a modulation signal generated by a driving signal modulator of an LED illumination unit according to another exemplary embodiment of the present invention.

The driving signal modulator generates a modulation signal 50R, 50G, or 50B instead of the modulation signal 40R, 40G, or 40B.

The modulation signal 50R, 50G, or 50B has a trapezoidal waveform pattern in which the level of the modulation signal 50R, 50G, or 50B decreases linearly from a peak value I_{q} to a value Iᵣ in a time interval from t₁ to t₅. Here, t₁<t₅<t₄, and Iᵣ<I₀<I_{q}.

I_{P}, Iᵣ, and the time interval from t₁ to t₅ can be set according to experiment results showing a relationship between a brightness decrease and a perceptual brightness change of a human eye. The peak value I_{P} is restricted by a limit on the amplitude and duration of the driving current of the LEDs 22R, 22G, and 22B, in order to prevent reducing the life spans of the LEDs 22R, 22G, and 22B.

The modulation signal 50R, 50G, or 50B is another example of a monotonically decreasing waveform signal. The function of the modulation signal 50R, 50G, or 50B is substantially the same as the function of the modulation signal 40R, 40G, or 40B.

The modulation signal of the current exemplary embodiment can be used for all or at least one of the LEDs 22R, 22G, and 22B, based on the heat generated by the LEDs 22R, 22G, and 22B, and interference among the LEDs 22R, 22G, and 22B. One or some of the LEDs 22R, 22G, and 22B that produce a small amount of heat and decrease less in brightness may be operated at a duty ratio of 100% in a given lighting time section.

Further, although there are three visible light emitting LEDs in the above-described embodiments, the number of the LEDs can be two, four, or more. For example, two red LEDs, two green LEDs, and two blue LEDs can be used. In addition, the plurality of LEDs can be separately disposed, instead of being assembled into a single light source.

Furthermore, although the LEDs are sequentially turned on for a given time period T₀, two or more of the LEDs can be simultaneously turned on in the given time period T₀. For example, the red, green, and blue LEDs can be simultaneously turned on to increase the apparent brightness.

Moreover, the projection display device can display images using a transmissive screen instead of a reflective screen. For example, the projection display device may be a rear projection television using a transmissive screen.

In addition, although the LED illumination unit is used in the projection display device, the LED illumination unit can be used in other devices, such as a lighting device or a projector, which irradiate light to a display medium, such as a reflective screen or a transmissive screen.

The components of the projection display device and the LED illumination unit can be used in different configurations within the scope of the present invention.

As described above, for the LED illumination unit, the projection display device using the LED illumination unit, and the method of operating the LED illumination unit, at least one LED of the LED illumination unit is operated at a duty ratio less than 100% with its lighting time section. Therefore, the heat emitting time of the LED is reduced. Further, the LED can release generated heat during off-duties. Thus, a brightness decrease due to the heat generated by the LED can be reduced, thereby increasing the reliability of the LED illumination unit.

While the present invention has been particularly shown and described with reference to exemplary embodiments thereof, it will be understood by those of ordinary skill in the art that various changes in form and details may be made therein without departing from the spirit and scope of the present invention as defined by the following claims and their legal equivalents.

What is claimed is:

1. A light emitting diode (LED) illumination unit comprising:
a light source comprising a plurality of LEDs; and
a lighting control unit which sequentially turns on the LEDs for lighting time sections which are assigned for each LED in a cyclic time period,
wherein the lighting control unit comprises a driving signal modulator which generates a modulation signal for turning on at least one of the LEDs with a lighting duty that is shorter than a lighting time section for the at least one of the LEDs.

2. The LED illumination unit of claim 1, wherein the driving signal modulator generates the modulation signal for turning on the at least one of the LEDs in the lighting time section by pulse-width modulation.

3. The LED illumination unit of claim 2, wherein the driving signal modulator perform the pulse-width modulation using a predetermined frequency so that at least two pulses are generated in the lighting time section.

4. The LED illumination unit of claim 1, wherein the modulation signal has a peak value during a first half of the lighting time section, and the driving signal modulator turns on the at least one of the LEDs in the lighting time section by power modulation.

5. The LED illumination unit of claim 4, wherein the modulation signal has the peak value at a start point of the lighting time section.

6. The LED illumination unit of claim 5, wherein the modulation signal has a waveform pattern which decreases monotonically with time.

7. The LED illumination unit of claim 5, wherein the modulation signal has a waveform pattern which decreases with time in a stepped fashion.

8. A projection display device which displays an image by irradiating light onto a screen at an enlarged size, the projection display comprising a light emitting diode (LED) illumination unit,
wherein the LED illumination unit comprises:
a light source comprising a plurality of LEDs; and
a lighting control unit which sequentially turns on the LEDs for lighting time sections which are assigned for each LED in a cyclic time period,
wherein the lighting control unit comprises a driving signal modulator which generates a modulation signal for turning on at least one of the LEDs with a lighting duty that is shorter than a lighting time section for the at least one of the LEDs.

9. The projection display device of claim 8, wherein the driving signal modulator generates the modulation signal for turning on the at least one of the LEDs in the lighting time section by pulse-width modulation.

10. The projection display device of claim 8, wherein the modulation signal has a peak value during a first half of the lighting time section, and the driving signal modulator turns on the at least one of the LEDs in the lighting time section by power modulation.

11. The projection display device of claim 10, wherein the modulation signal has the peak value at a start point of the lighting time section and a waveform pattern which decreases monotonically with time.

12. A method of operating a light emitting diode (LED) illumination unit, the method comprising sequentially turning on a plurality of LEDs of the LED illumination unit for lighting time sections which are assigned for each LED in a cyclic time period,
wherein at least one of the LEDs is turned on with a lighting duty which is shorter than a lighting time section of the at least one of the LEDs.
